(19) United States
(12) Patent Application Publication
(10) Pub. No.: US 2014/0197022 A1
(43) Pub. Date: Jul. 17, 2014

(54) SOLAR-POWERED HUMIDIFICATION-DEHUMIDIFICATION DESALINATION SYSTEM

(71) Applicants: KING FAHD UNIVERSITY OF PETROLEUM AND MINERALS, Dhahran (SA); KING ABDULAZIZ CITY FOR SCIENCE AND TECHNOLOGY, Riyadh (SA)

(72) Inventors: MOHAMED ABDELKARIM ANTAR, DAHRAH (SA); MOSTAFA HAMED ELSHARQAWY, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/741,998

(22) Filed: Jan. 15, 2013

(51) Int. Cl. C02F 1/14

(52) U.S. Cl. CPC C02F 1/14
USPC 202/174

(57) ABSTRACT

The solar-powered humidification-dehumidification desalination system includes a supply of saline/brackish water passing through a dehumidifier/condenser. The saline/brackish water is preheated in the dehumidifier/condenser due to the condensation process. A plurality of humidifying stages includes respective humidifiers and respective solar collectors. The solar collectors heat air, and the heated air passes through respective humidifiers to evaporate the preheated saline/brackish water, separating pure water from the brine. The humid air is reheated and recirculated through the humidifying stages and the dehumidifier, and the desalinated water from the dehumidifier via condensation is collected to and processed. The system recirculates the brine successively from each humidifier to the next for more efficient evaporation and less energy consumption.

### BACKGROUND OF THE INVENTION

1. Field of the Invention

The present invention relates to water treatment systems, and particularly to a solar-powered humidification-dehumidification desalination system that provides environmentally friendly and energy-efficient desalination of seawater and brackish water and increased production thereof.

2. Description of the Related Art

Small- to moderate-scale water desalination systems are expected to be vital for hot and arid areas, where natural sources of water are absent and access to sweet water pipelines is considered challenging, either due to lack of energy sources to run a desalination system or to isolated geographical territories. These locations have an abundance of solar energy that provides a suitable environmentally friendly energy source.

One of the moderate-scale water production systems that utilizes solar energy is the humidification dehumidification (HDH) system. HDH systems have received significant attention from researchers within the last decade. These units have a significant benefit over solar stills, where solar collection, water heating, evaporation, and condensation are all integrated in a single “box”. The solar still configuration results in considerable thermal inefficiency and produces a limited amount of desalinated water in the range of 5-7 L/m² per day.

Humidification-dehumidification (HDH) desalination uses separate components for each of the thermal processes, allowing each component to be independently designed and allowing much greater flexibility in the design of the thermodynamic cycle for vaporizing water into air and subsequently condensing the vapor. The advantage of HDH over a solar still is a significantly higher Gain Output Ratio (GOR), which is the amount of fresh water produced per thermal energy added per latent heat of vaporization. This results in a smaller total area of solar collectors for a given water demand. More broadly, HDH systems are regarded as having an advantage over some other technologies, such as reverse osmosis, since they involve relatively simple, inexpensive components and can operate over a wide range of raw water quality without the need for pretreatment or complex maintenance operations. This makes HDH more suitable for deployment in the developing world, where capital investment and technical support may be more limited.

One of the concerns of the HDH system is that the thermal energy requirements are still relatively high in comparison with other technologies, i.e., the GOR is less than other thermal desalination processes, such as Multi-Stage Flash (MSF) and Multi-Effect Distillation (MED). HDH cycles may be classified according to whether air or water is heated and according to whether the air or water circuit is open or closed.

Examples of an air-heated, closed-air, closed-water cycle of the prior art are shown in FIGS. 1-3. As shown in FIGS. 1-3, prior art humidification dehumidification desalination systems use solar energy to desalinate saline/brackish water. FIGS. 1 and 3 show two-stage humidification dehumidification systems 10, 200, and a three-stage humidification dehumidification system 100 is shown in FIG. 2. Either can be extended to N-stage systems.

The layouts for the above systems are similar. They include solar collectors 12, 112, 212 for heating air. Heated air 13, 113, 213 from the solar collectors 12, 112, 212 passes through respective first-stage humidifiers 14, 114, 214, second-stage humidifiers 16, 116, 216, and in some systems, third-stage humidifiers 130, 230. Preheated brackish water or seawater 19, 119, 219 is sprayed inside the humidifiers 14, 16, 114, 116, 130, 214, 216, 230, allowing the brackish water 19, 119, 219 to evaporate. This evaporation separates the sweet water from the brine 17, 117, 217. The brine 17, 117, 217 from each humidifier is collected in a brine tank 20, 120, 220. In these closed loop systems, the brine 20, 120, 220 supplies the brackish water for treatment and the collected brine therein is cycled towards the dehumidifier/condenser 18, 118, 218 via the supply line 21, 121, 221.

When the heated air 13, 113, 213 passes through the humidifiers, the air becomes humid air 15, 115, 215 due to the moisture collected during the evaporation. This humid air 15, 115, 215 is reheated via the adjacent solar collector 12, 112, 212 to provide the necessary hot air for either the humidifying process or the condensation process in the dehumidifier.

In the dehumidifier 18, 118, 218, the incoming brackish water or seawater 21, 121, 221 is at a much lower temperature than the humid air 15, 115, 215. Thus, heat exchange between the seawater and the humid air produces condensation and the desalinated water therefrom is collected through the desalinated water line 23, 123, 223. The cooled air 11, 111, 211 from the dehumidifier is fed back to the solar collector 12, 112, 212.

In the alternative humidification dehumidification desalination system 200 shown in FIG. 3, seawater and the brine are separated, rather than mixed as in the desalination systems 10, 100. The brine tank 220 facilitates continuous processing of brine, while the seawater tank 240 circulates seawater through the dehumidifier 218 in a continuous loop via the seawater inlet line 241 and the seawater outlet line 243. In this embodiment, no preheated seawater is conveyed to the humidifiers.

It will be noted that in the three systems shown in FIGS. 1-3, water dispensed from the brine tank (after preheating by being used in the condenser of the dehumidification stage to cool and evaporate hot air from the humidifier stages) is dispensed to each of the humidifier stages in parallel. The resulting brine, which is more concentrated due to loss of fresh water to the heated air, is returned separately from each humidifier to the brine tank. For example, in FIG. 1, brine is dispensed from the brine tank 20 to the dehumidifier 18 by conduit 21, where the brine (seawater) is preheated by heat exchange with the hot humidified air. The preheated brine is then dispensed to the second-stage humidifier 16 and the first stage humidifier 14 in parallel via conduit 19. Brine that is left over after the humidification stages is independently returned to the brine tank 20 by both the first-stage humidifier 14 and the second-stage humidifier 16 via conduits 17.

Several studies have been conducted relating to water-heated cycles and air-heated cycles that suggest the above. It has been shown by thermodynamic analysis that the addition of more stages may increase the desalinated water productivity slightly. However, it decreases the parameter used for cycle performance assessment, i.e. GOR. In other words, while the prior art of FIGS. 1-3 can produce desalinated water, the output thereof is less than optimal for the given amount of added thermal energy.

In light of the above, it would be a benefit in the art of water treatment systems to provide a desalination system that maximizes GOR for a given energy input. Thus, a solar-powered humidification-dehumidification desalination system solving the aforementioned problems is desired.

### SUMMARY OF THE INVENTION

The solar-powered humidification-dehumidification desalination system includes a supply of seawater or brackish water passing through a dehumidifier/condenser. The brackish water is preheated in the dehumidifier/condenser due to the condensation process. A plurality of humidifying stages includes respective humidifiers and respective solar collectors. The solar collectors heat air, and the heated air passes through the respective humidifiers to evaporate the preheated seawater or brackish water, separating pure water from the brine. The humid air is reheated and recirculated through the humidifying stages and the dehumidifier, and the desalinated water from condensation in the dehumidifier is collected and processed. The system recirculates the brine from each humidifier, utilizing the latent heat therein for more efficient evaporation and less energy consumption.

In the present system, seawater or brine released from the brine tank is circulated through the multiple humidifier stages in series (after preheating by use as a heat exchanger in the dehumidifier), from the last humidification stage in sequence to the first humidification stage before returning to the brine tank.

These and other features of the present invention will become readily apparent upon further review of the following specification and drawings.

### BRIEF DESCRIPTION OF THE DRAWINGS

FIG. 1 is a schematic diagram of a two-stage humidification dehumidification desalination system according to the prior art.

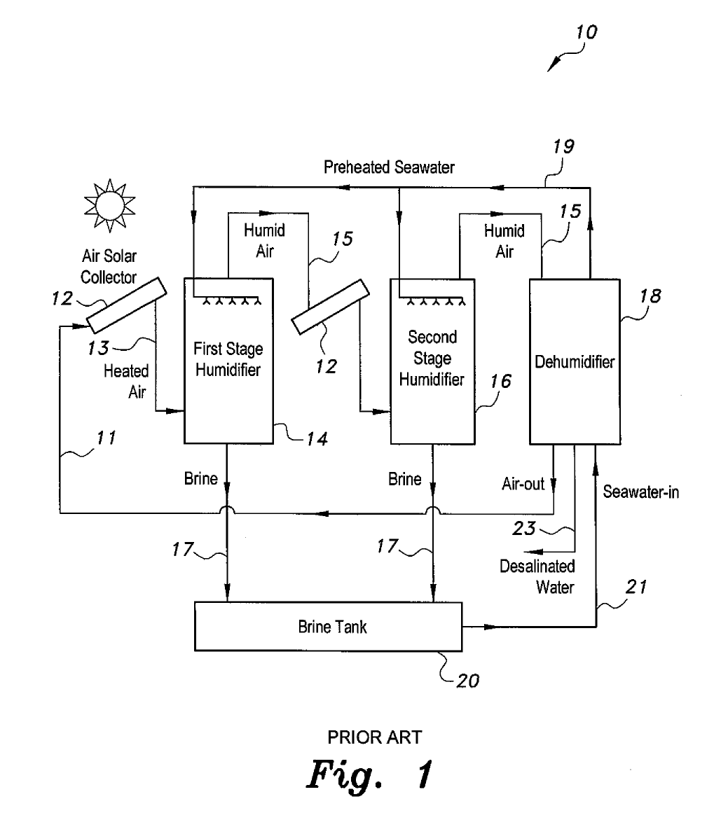

FIG. 2 is a schematic diagram of a three-stage humidification dehumidification desalination system according to the prior art.

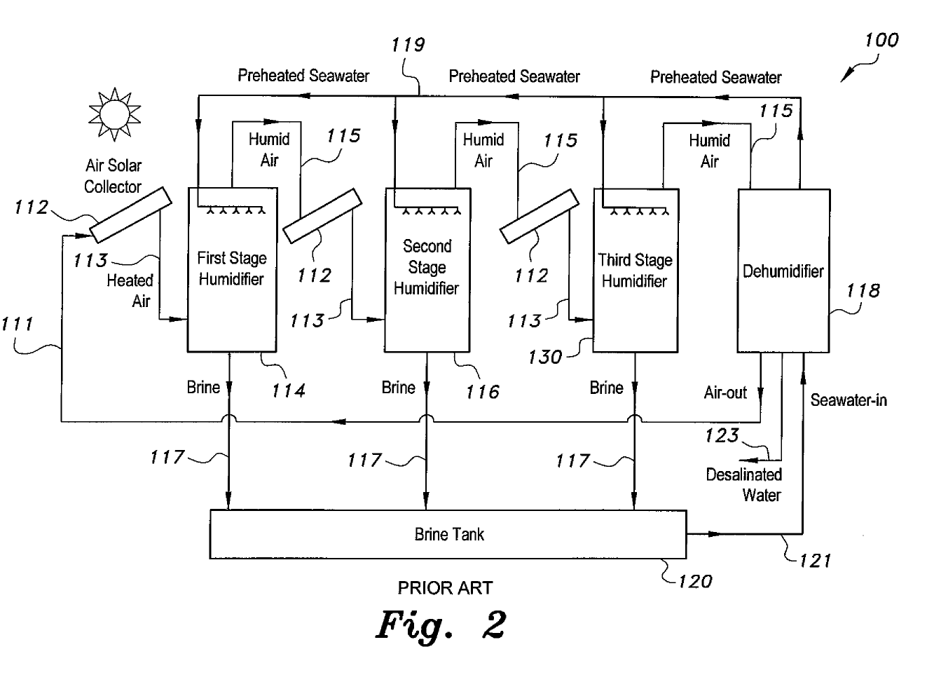

FIG. 3 is a schematic diagram of an alternative embodiment of a two-stage humidification dehumidification desalination system according to the prior art.

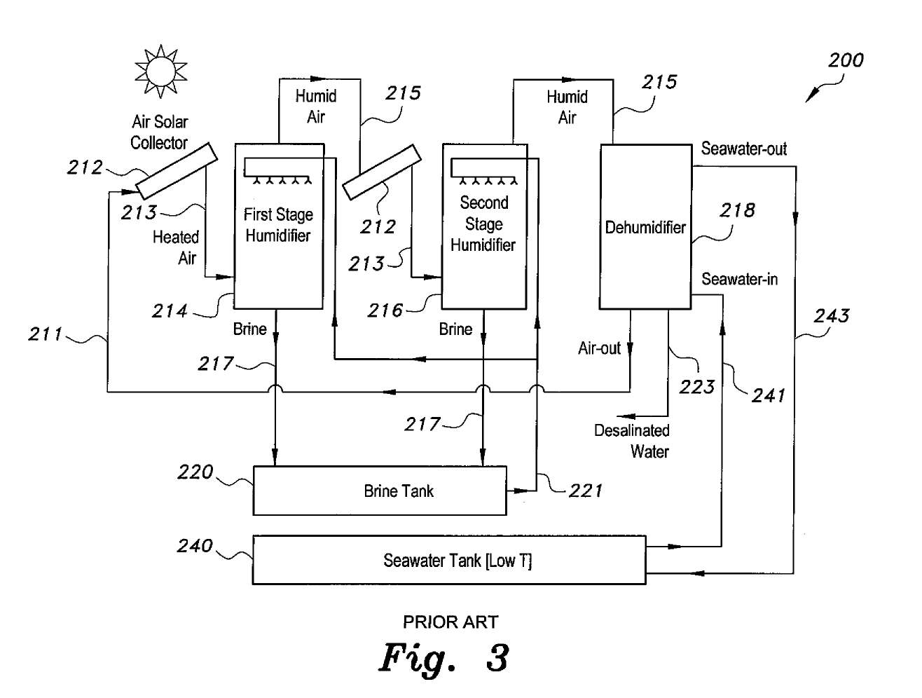

FIG. 4 is a schematic diagram of a solar-powered humidification-dehumidification desalination system according to the present invention.

FIG. 5 is a schematic diagram of an alternative embodiment of a solar-powered humidification dehumidification desalination system according to the present invention.

FIG. 6 is a schematic diagram of a further alternative embodiment of a solar-powered humidification dehumidification desalination system according to the present invention.

Similar reference characters denote corresponding features consistently throughout the attached drawings.

### DETAILED DESCRIPTION OF THE PREFERRED EMBODIMENTS

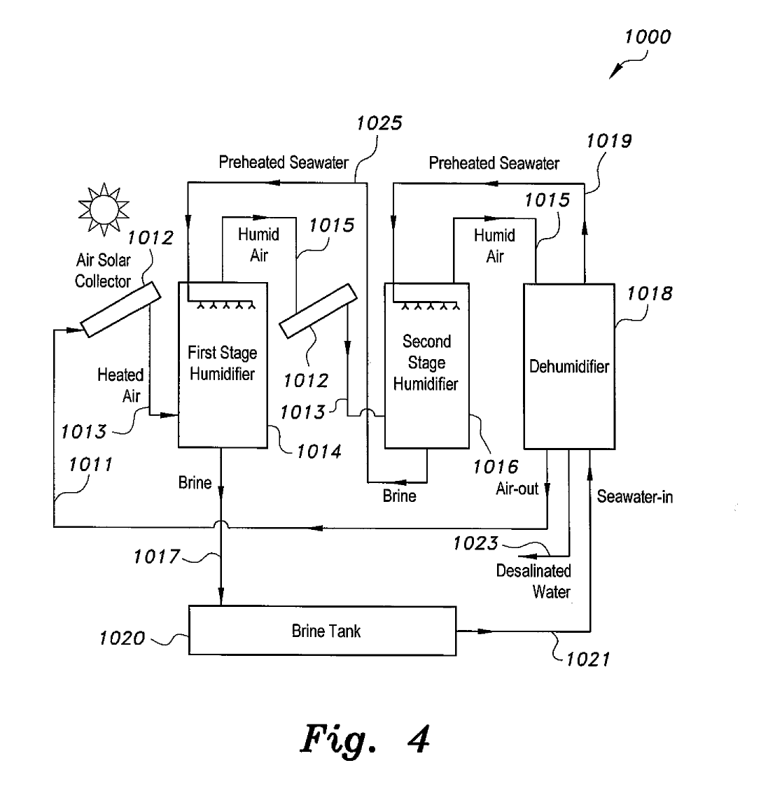

The solar-powered humidification-dehumidification desalination system, hereinafter referred to as the multi-stage air-heated humidification-dehumidification MSAHHDH desalination system, utilizes latent or residual heat energy in the brine to increase thermal efficiency and desalinated water production in the desalination process. As shown in FIG. 4, in a first embodiment, the MSAHHDH desalination system 1000 is a two-stage process that includes a plurality of solar collectors 1012, each being operatively connected to a corresponding first-stage humidifier 1014 and a second-stage humidifier 1016. The solar collector 1012 adjacent the first-stage humidifier 1014 supplies heated, relatively dry air 1013 for the humidification process, while the solar collector 1012 adjacent the second-stage humidifier 1016 reheats the humid air from the first-stage humidifier 1014. The heated air 1013 crosses streams with preheated brackish water or seawater 1019, 1025 sprayed inside the humidifiers 1014, 1016, causing evaporation. The relatively dry heated air 1013 becomes humid by water evaporated from the preheated brackish water 1019, 1025, thereby separating pure water from the brine.

Unlike the prior art conventional HDH systems, the MSAHHDH desalination system 1000 uses the residual or latent heat in the saline/brackish water or seawater to conserve energy required for the desired vaporization. In the prior art systems, the preheated saline/brackish water is supplied in parallel to all the humidifiers from the same source, i.e. through the dehumidifier/condenser 18. For any given temperature of the saline/brackish water, there is some heat loss prior to reaching the humidifiers due to the common source of the preheated saline/brackish water and the length of travel thereof which plays a contributing factor to said heat loss. In contrast, the MSAHHDH desalination system 1000 minimizes any heat loss, since the preheated saline/brackish water is supplied from a closer source and maintained at relatively higher temperature than conventional systems. For example, the preheated saline/brackish water 1019 for the second-stage humidifier 1016 is supplied directly from the dehumidifier 1018, while the preheated saline/brackish water 1025 for the first-stage humidifier 1014 is supplied directly from the brine of the second-stage humidifier 1016, the brine being the remainder of the saline water that has not evaporated. In the latter case, the brine 1025 is already at an elevated temperature as a result of the humidifying process performed on the preheated seawater or brackish water 1019 from the dehumidifier/condenser 1018. Due to the above, the preheated saline water is at a higher temperature than in the conventional system. This translates to a smaller temperature difference to overcome in order to humidify the incoming air in the first-stage humidifier 1014, thereby making the process more energy efficient by reducing energy consumption required to reach the desired temperature for maximal evaporation in the humidifiers.

As the brine 1025 circulates from the second-stage humidifier 1016 to the first-stage humidifier 1014 for further humidification, the resultant brine is collected in one place, viz., the first-stage humidifier 1014. The collected brine 1017 flows in to a collection tank, such as the brine tank 1020, via gravity. In this closed-loop system, the brine tank 1020 holds the brine 1017 from the humidifiers 1014, 1016, as well as the main supply of saline water to be processed, such as seawater. Since the seawater will be at a much lower temperature than the brine, mixing of both will also significantly lower the temperature of the brine 1017. This forms the main saline water supply 1021 piped into the dehumidifier/condenser 1018.

In the dehumidifier/condenser 1018, pure water vapor is separated by condensation from the moist air 1015. The condensation occurs through thermodynamic heat exchange between the cold incoming saline water supply 1021 and the incoming hot, humid air 1015 from the second-stage humidifier 1016. In this embodiment, the saline water supply 1021 is admitted through tubes in the dehumidifier/condenser 1018, and the hot, humid air 1015 condenses on the outside surface of the tubes. The condensed, desalinated water 1023 is collected and pumped out of the dehumidifier/condenser 1018 to an exterior holding tank. The cooled air 1011 from the condensation process cycles back to the solar collector 1012 associated with the first-stage humidifier 1014, repeating the humidifying dehumidifying process.

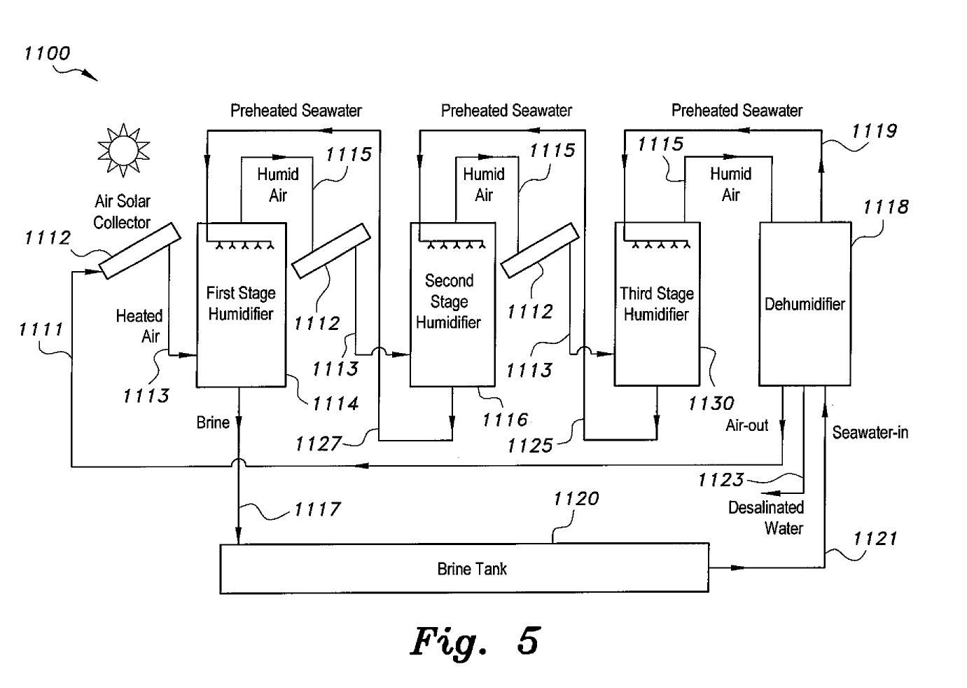

As noted above, the process described above can be applied to N^{th} degree of stages. FIG. 5 shows an example of a three-stage MSAHHDH desalination system 1100. In this embodiment, the MSAHHDH desalination system 1100 includes a first-stage humidifier 1114, a second-stage humidifier 1116 and a third-stage humidifier 1130. A solar collector 1112 is operatively connected to each humidifier 1114, 1116, 1130, where the solar collector 1112 connected to the first-stage humidifier 1114 heats the cold air 1111 from the dehumidifier/condenser 1118, the solar collector 1112 connected to the second-stage humidifier 1116 reheats the incoming humid air 1115 from the first-stage humidifier 1114, and the solar collector 1112 connected to the third-stage humidifier 1130 reheats the incoming humid air 1115 from the second-stage humidifier 1116. The humid air 1115 from the third-stage humidifier 1130 is fed through the dehumidifier/condenser 1118 for the condensation process, and the cooled air 1111 therefrom is fed back to the solar collector 1112 connected to the first-stage humidifier 1114 to repeat the humidifying dehumidifying process.

As with the MSAHHDH desalination system 1000, the desalination process begins with saline water from the brine tank 1120. The saline water 1121 can be primarily seawater or a mixture of seawater and brine from the first-stage humidifier 1114. This saline water 1121 becomes the preheated saline/brackish water 1119 supplying the humidification process in the third-stage humidifier 1130. The brine from the third-stage humidifier 1130 becomes the preheated saline/brackish water 1125 for the second-stage humidifier 1116, and the brine from the second-stage humidifier 1116 cycles into the first-stage humidifier 1114, where the resulting brine 1117 recycles back to the brine tank 1120. Pure or desalinated water 1123 condenses within the dehumidifier 1118 and flows to a collection tank.

As with the MSAHHDH desalination system 1000, the MSAHHDH desalination system 1100 utilizes thermal energy more efficiently by maximizing the latent heat recovery in the saline water from the dehumidifier 1118 and the brine from the second and third humidifiers 1116, 1130 to the respective humidifiers. The energy required to heat the air for the evaporation process is much less than in conventional systems when assisted by this residual heat.

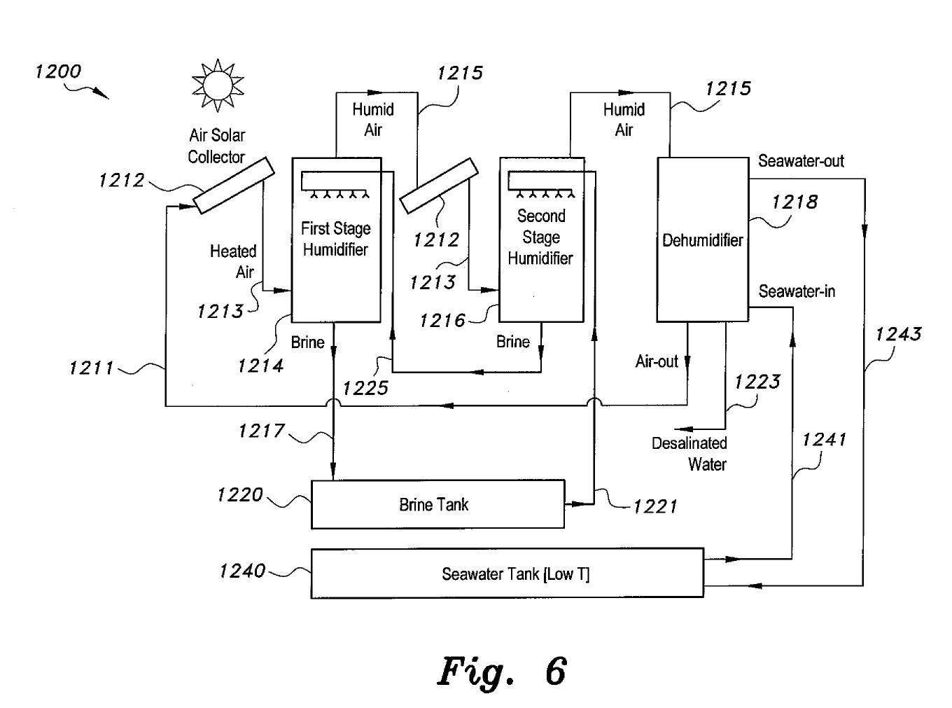

The MSAHHDH desalination system 1200 shown in FIG. 6 is similar to the two-stage MSAHHDH desalination system 1000, except for separation of the brine flow and the seawater flow. In this embodiment, the MSAHHDH desalination system 1200 is a two-stage system having a first-stage humidifier 1214, a second-stage humidifier 1216 and a solar collector 1212 operatively connected to each humidifier. The cooled air 1211 from the dehumidifier/condenser 1218 circulates through the solar collector 1212 to be heated, and the heated air 1213 passes through the first-stage humidifier 1214. The humid air 1215 therefrom is also heated by another solar collector 1212, and the heated air 1213 circulates through the second-stage humidifier 1216. The humid air 1215 from the second-stage humidifier 1216 is passed through the dehumidifier/condenser 1218 to be recycled and repeat the process.

As mentioned above, in this embodiment, the brine and the seawater are held in separate tanks, e.g., the brine tank 1220 (preferably, the brine tank 1220 is insulated to maintain the brine at elevated temperature) and the seawater tank 1240. The brine tank 1220 facilitates collection of the brine 1217 from the first-stage humidifier 1214 and circulates the same through the second-stage humidifier 1216, and then in series to the first-stage humidifier 1214. The brine processed through this sub-system maintains elevated temperatures conducive for efficient humidification in the humidifiers 1214, 1216, since the main heat loss for the brine occurs within the humidifiers 1214, 1216 rather than through the dehumidifier/condenser 1218.

Subsequently, the seawater processing sub-system mainly recirculates the seawater through the dehumidifier/condenser 1218. The seawater tank 1240 provides the incoming seawater 1241 for the dehumidifier/condenser 1218 and circulates the same from the dehumidifier 1218 as outgoing seawater 1243 back to the seawater tank 1240. This permits a more efficient and productive condensation to occur within the dehumidifier 1218 due to the incoming seawater 1241 being maintained at a relatively constant colder temperature than the hot, humid air 1215 passing through the dehumidifier 1215, i.e., the temperature difference between the humid air 1215 and the seawater 1241 is high. In contrast to the other MSAHHDH desalination systems 1000, 1100, the seawater does not mix with the brine, which would cause the cooling medium, e.g., the seawater and brine mixture, to be at an equilibrium temperature, the equilibrium temperature effectively being lower than in the current MSAHHDH desalination system 1200. The condensation is collected in the dehumidifier 1218, and the desalinated water 1223 is piped for further processing.

It is to be understood that the present invention is not limited to the embodiments described above, but encompasses any and all embodiments within the scope of the following claims.

We claim:

1. A solar-powered humidification-dehumidification desalination system, comprising:
a reservoir of saline water;
a plurality of humidifiers disposed in successive stages from a first stage to a last stage, each of the humidifiers having a solar collector for heating air and a sprayer for spraying the saline water into the heated air, whereby pure water evaporates from the saline water to form heated humidified air;
a dehumidifier stage for condensing water vapor from the heated humidified air;
a system of air conduits connecting the humidifier stages and the dehumidifier stage, the system of air conduits being configured to circulate air from the first humidifier stage through the last humidifier stage to produce successive stages of the heated humidified air, and from the last humidifier stage to the dehumidifier for condensation of desalinated water from the heated humidified air, and back to the first stage humidifier to recycle the air; and
a system of saline water conduits connecting the humidifier stages and the reservoir of saline water, the system of saline water conduits being configured to circulate the saline water sequentially from the last humidifier stage through the first humidifier stage to the reservoir of saline water.

2. The solar-powered humidification-dehumidification desalination system according to claim 1, wherein said plurality of humidifiers comprises a first-stage humidifier and a second-stage humidifier operatively connected to each other in successive stages.

3. The solar-powered humidification-dehumidification desalination system according to claim 1, wherein said plurality of humidifiers comprises a first-stage humidifier, a second-stage humidifier, and a third-stage humidifier operatively connected to each other in successive stages.

4. The solar-powered humidification-dehumidification desalination system according to claim 1, wherein:
said reservoir of saline water comprises a brine tank; and
said system of saline water conduits includes a conduit connecting said brine tank to said dehumidifier stage and a conduit connecting said dehumidifier stage to said last humidifier stage, whereby the saline water from the brine tank forms a heat exchange medium for said dehumidifier stage and is preheated for circulation to said last humidifier stage.

5. The solar-powered humidification-dehumidification desalination system according to claim 1, wherein said reservoir of saline water comprises a brine tank, the system further comprising a seawater tank, the brine tank holding brine from said first-stage humidifier and recycling the brine to said last-stage humidifier, the seawater tank holding seawater recirculating through said dehumidifier stage in a separate loop, providing a heat exchange medium for said dehumidifier stage.

6. An energy-efficient desalination process, comprising the steps of:
providing a multistage air-heated humidification dehumidification desalination system;
circulating air through successive stages of humidification by brine and then to a dehumidifier for condensation of desalinated water from the heated, humidified air;
recirculating air from the dehumidifier to the successive stages of humidification, thereby forming a closed loop air circulation system; and
circulating the brine through the successive stages of humidification in reverse order and then to a brine reservoir, whereby the brine is preheated and successively concentrated.

7. The energy-efficient desalination process according to claim 6, wherein said system comprises a first humidification stage and a second humidification stage, said step of recirculating the brine comprising circulating brine from the second humidification stage to the first humidification stage, and then to the brine reservoir.

8. The energy-efficient desalination process according to claim 6, wherein said system comprises a first humidification stage, a second humidification stage, and a third humidification stage, said step of recirculating the brine comprising circulating brine from the third humidification stage to the second humidification stage, then from the second humidification stage to the first humidification stage, and then to the brine reservoir.

9. The energy-efficient desalination process according to claim 6, further comprising the steps of:
circulating brine from the brine reservoir to the dehumidification stage;
using the brine as a heat exchange medium in the dehumidification stage; and
then performing said step of circulating the brine through the successive stages of humidification in reverse order.

10. The energy-efficient desalination process according to claim 6, wherein said system comprises both the brine reservoir and a seawater tank, said step of circulating the brine through the successive stages of humidification in reverse order further comprising circulating brine from the brine reservoir directly to the successive stages of humidification, the process further comprising the step of recirculating seawater from the seawater tank to and from the dehumidification stage for use as a heat exchange medium.
